(19) United States
(12) Patent Application Publication
(10) Pub. No.: US 2004/0154003 A1
(43) Pub. Date: Aug. 5, 2004

(54) Code generation apparatus, code generation program, simulation apparatus, simulation program, model generation apparatus, and model generation program

(75) Inventors: Masaya Oi, Okazaki-city (JP); Yoshitaka Uematsu, Anjo-city (JP); Akihito Iwai, Chiryu-city (JP)

Correspondence Address: NIXON & VANDERHYE, PC, 1100 N GLEBE ROAD, 8TH FLOOR, ARLINGTON, VA, 22201-4714, US

(73) Assignee: DENSO CORPORATION, Aichi-pref (JP)

(21) Appl. No.: 10/761,207

(22) Filed: Jan. 22, 2004

(30) Foreign Application Priority Data
Jan. 27, 2003 (JP) 2003-17668

(51) Int. Cl. G06F 9/44; H04B 1/74

(52) U.S. Cl. 717/135; 714/38

(57) ABSTRACT

A personal computer includes a code generation tool to generate a source code from a given model compliant with a plurality of variations. From an HDD, the computer acquires the given model including a plurality of part specification blocks, each of the part specification blocks specifies a specific part of the given model. From the HDD or an input apparatus, the computer acquires selection information indicating that a given specific part of the given model is to be selected or deleted using the corresponding part specification block. Based on the selection information, the computer thereby generates a source code from an intermediate model where unnecessary part is deleted from the given model.

### CROSS REFERENCE TO RELATED APPLICATIONS

This application is based on and incorporates herein by reference Japanese Patent Application No. 2003-17668 filed on Jan. 27, 2003.

### FIELD OF THE INVENTION

The present invention relates to a code generation apparatus, a code generation program, a simulation apparatus, a simulation program, a model generation apparatus, and a model generation program used for model-based program development.

### BACKGROUND OF THE INVENTION

Conventionally, developers may create a program to operate vehicle's engine ECU without directly describing program's source codes. In this case, they may describe functions of the intended program in the form of “model” which is easier to create and excels in visibility. The developers use workstations, personal computers, and the like that are installed with the program development environment corresponding to the model. Based on the model, the developers verify and test operations of the intended program and generate a source code from the model. In the description to follow, a term “simulation tool” is used to represent a program that has functions of verifying and testing operations of the intended program. Further, a term “code generation tool” is used to represent a program that has functions of generating a source code from the model. In some cases, the code generation tool and the simulation tool are integrated into the model development environment from the beginning. In other cases, the code generation tool and the simulation tool are installed as additional modules into the model development environment later on.

There is available Matlab (registered trademark) as a model-based program development environment. Developers use Simulink (registered trademark), one of Matlab (registered trademark) functions, to describe intended program's functions as a combination of function units called blocks. An aggregate of combined blocks constitutes a model. For example, Simulink (registered trademark) blocks include a block to generate sine functions, a block to read data from files, a block to perform specific addition, subtraction, multiplication, and division for input data, and a higher-order block including a combination of blocks to constitute a subsystem.

In the program development, for example, a developer generates a model and uses the code generation tool to generate a source code from the model. Finally, a program is generated from the source code. According to this procedure, the model created at the initial stage can be used to represent the program. This can provide advantageous effects such as improving visibility of the program's functions.

There may be the case of creating a plurality of types of the above-mentioned program for engine ECU according to variations, i.e., engine types such as V6 (V type-six cylinders), V8 (V type-eight cylinders), and I6 (in-line type-six cylinders), destination countries such as Japan, Europe, and the United States of America, and intended uses such as delivery to manufacturers and debugging.

These variations have factors common to each other. It is possible to decrease costs for development and management of the program by creating one model including the variations rather than independently developing models for the individual variations.

For creating a plurality of types of source codes corresponding to the variations from one model, following conditions are to be met. First, the model needs to express differences between the variations. Second, the model can be selected to generate source codes corresponding to the variations. For this purpose, a changeover method using a block having a switch function has been conventionally used. FIG. 17 shows part of a model represented by this conventional changeover method.

Each of a V6 subsystem 51, a V8 subsystem 52, and an I6 subsystem 53 represents an aggregate of blocks. The V6 subsystem 51, the V8 subsystem 52, and the I6 subsystem 53 describe processes corresponding to variations for a V6 engine, a V8 engine, and an I6 engine, respectively. These subsystems output specified operation results defined by the blocks assigned to the subsystems. An input terminal 55 is used to input a selection signal a as a value assignable to a selection block 54.

The selection block 54 has a function to output any one of operation results supplied from the V6 subsystem 51, the V8 subsystem 52, and the I6 subsystem 53 based on an input value from the input terminal 55.

Suppose that a code generation tool is used to convert the model including these components into a source code. Here, for example, FIG. 18 shows a source code fragment corresponding to the contents in FIG. 17.

In FIG. 18, a Switch statement in the source code applies to the contents enclosed in braces { }. When argument a is assigned value 1, 2, or 3, the Switch statement defines to execute a statement between case 1:, case 2:, or case 3: and the immediately succeeding break statement, respectively. The Switch statement corresponds to the selection block 54. Argument a corresponds to selection signal a. The code between case 1: and the immediately succeeding break statement corresponds to the V6 subsystem 51. The code between case 2: and the immediately succeeding break statement corresponds to the V8 subsystem 52. The code between case 3: and the immediately succeeding break statement corresponds to the I6 subsystem 53.

When the source code is generated in this manner, setting the selection signal a to value 1 executes part of the source code corresponding to the V6 subsystem 51. Part of the source code corresponding to V8 or 16 is not executed. Therefore, the generated code can implement the variations in accordance with the selection signal a. However, the source code includes unused parts in form. When such source code is complied, a generated program will contain unnecessary source codes, increasing the program size. This could result in an uneconomical use of the capacity of memory to store the program.

### SUMMARY OF THE INVENTION

The present invention has been made in consideration of the foregoing. It is therefore an object of the present invention to provide a program development environment to generate a source code using a model corresponding to a plurality of variations so as to exclude unnecessary parts of the model from the generated source code.

In order to solve the above-mentioned problems, the present invention provides a code generation apparatus with the following. A given model whose specific part is specified by a part specifier is acquired. Selection information capable of indicating at least one of selection and deletion of the specific part using the part specifier is acquired. The source code is generated from a certain model that is generated using the acquired given model based on the acquired selection information.

In this manner, for instance, since a part specifier can specify unnecessary part of a given model, the unnecessary part is deleted from a generated source code in accordance with selection information. Therefore, in a program development environment where a given model compliant with a plurality of variations generates a source code, part of the source code corresponding to unnecessary variations can be removed from an intended source code.

A given model may include a plurality of part specifiers. Here, various parts of the given model can be designated for a selection target or a deletion target based on selection information using one, more, or all of the part specifiers.

### BRIEF DESCRIPTION OF THE DRAWINGS

The above and other objects, features, and advantages of the present invention will become more apparent from the following detailed description made with reference to the accompanying drawings. In the drawings:

FIG. 1 shows a configuration of a personal computer as a code generation apparatus according to a first embodiment of the present invention;

FIG. 2 schematically shows a configuration and operations of a code generation tool according to the first embodiment;

FIG. 3 shows an example of a model input to the code generation tool;

FIG. 4A diagrams a block for V6 and I6 subsystems to add and output states of engine cylinders;

FIG. 4B diagrams a block for a V8 subsystem to add and output states of an engine cylinder;

FIG. 5 is a flowchart showing a process of the code generation tool to generate a source code from a model;

FIG. 6 shows part of an intermediate model generated from the model in FIG. 3;

FIG. 7 shows an example of the model input to the code generation tool according to a second embodiment;

FIG. 8 is a flowchart showing a process of the code generation tool to generate a source code from a model according to the second embodiment;

FIG. 9 shows part of an intermediate model generated from the model in FIG. 7;

FIG. 10 schematically shows a configuration and operations of a code generation tool according to a third embodiment;

FIG. 11 shows an example of the model 3 input to the code generation tool according to the third embodiment;

FIG. 12 shows an example of a changeover matrix;

FIG. 13 is a flowchart showing a process of the code generation tool to generate a source code from a model according to the third embodiment;

FIG. 14 shows part of an intermediate model generated from the model in FIG. 11;

FIG. 15 schematically shows a configuration and operations of a simulation tool according to a fourth embodiment;

FIG. 16A diagrams part of block configuration in a subsystem created for the USA;

FIG. 16B diagrams part corresponding to FIG. 16A in a subsystem created for countries other than the USA;

FIG. 17 shows part of a model represented by a conventional changeover method; and

FIG. 18 shows a source code corresponding to the part in FIG. 17.

### DETAILED DESCRIPTION OF THE PREFERRED EMBODIMENTS

(First Embodiment)

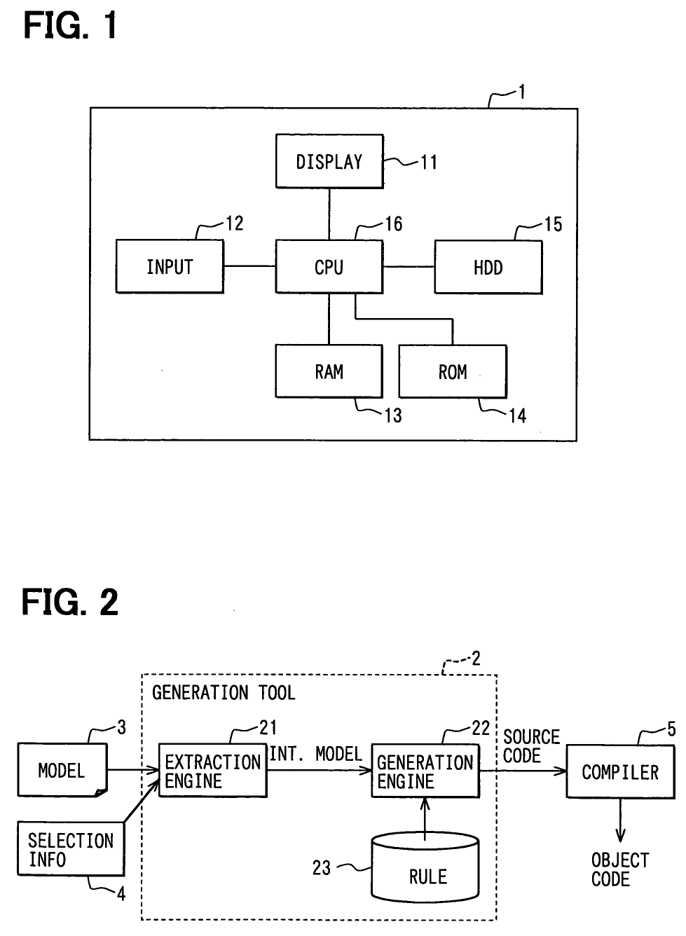

FIG. 1 shows a personal computer 1 as the code generation apparatus according to the embodiment of the present invention. The personal computer 1 includes a display 11, an input apparatus 12, a RAM (Random Access Memory) 13, a ROM (Read-Only Memory) 14, an HDD (Hard Disk Drive) 15, and a CPU 16.

The display 11 receives a video signal from the CPU 16 and displays this signal as a video image to users.

The input apparatus 12 includes a keyboard, a mouse, and the like and is operated by a user to output a signal corresponding to the operation to the CPU 16.

When the personal computer 1 is turned on, the CPU 16 starts to read a specified boot program from the ROM 14. To perform a startup process, the CPU 16 reads and executes an operating system (hereafter acronymed as an OS) such as MS-Windows (registered trademark) and the other programs from the HDD 15. The OS and the other programs are specified in the boot program. After the startup process until the power is turned off, the CPU 16 executes various programs recorded on the HDD 15 as processes running on the OS based on signals from the input apparatus 12 and predetermined schedules. During the startup process and the other processes, the CPU 16 accepts signals input from the input apparatus 12 as needed. The CPU 16 outputs video signals to the display 11 and controls reading and writing data to the RAM 13 and the HDD 15.

FIG. 2 schematically shows a configuration and operations of the code generation tool 2, i.e., one of programs that are stored in the HDD 15 and are executed as processes on the OS. The code generation tool 2 starts in response to a user operation on the input apparatus 12 in accordance with the OS specifications. Thereafter, the code generation tool 2 generates source codes from a model based on user's operations on the input apparatus 12.

A source code is one of program representations created by a program developer in accordance with specifications of programming languages such as C++. The source code is input to a compiler and linker, etc., and is converted into an object code directly executable on the CPU and the like. The object code is also one of program representations.

Further, a model is also one of program representations. Models allow simpler descriptions than source codes and are created in accordance with model language specifications established for improved human readability. Models include Simulink models created by Simulink (registered trademark), for example. When a Simulink (registered trademark) model is input to Real Time Workshop (registered trademark, hereafter acronymed as RTW) running on Matlab (registered trademark), RTW generates a source code corresponding to the Simulink (registered trademark) model.

The Simulink (registered trademark) model is created as an aggregate including combinations of function units called blocks. A combination refers to an input/output connection between function units. As an example of blocks, there is provided an addition block that adds two pieces of input numeric data to each other and outputs a result. Further, an aggregate of blocks as a subsystem can be defined as a type of block. That is to say, it is permitted to create a nested block that contains a block in another block. Blocks in the Simulink (registered trademark) model can have corresponding attribute information. For example, the attribute information includes a name of each block, the definition of areas for values of input/output data, and the like.

Like Simulink (registered trademark) models, the model according to the embodiment also includes blocks. Nested blocks are permitted. Each block can have attribute information.

The code generation tool 2 can be categorized into a generation model extraction engine 21, a code generation engine 22, and a generation rule 23, from the viewpoint of functions.

The generation model extraction engine 21 generates an intermediate model based on a model 3 and selection information 4 that are input. The intermediate model also belongs to models.

The code generation engine 22 generates a source code from the intermediate model generated by the generation model extraction engine 21. The generation rule 23 provides information specifying rules to generate source codes from the intermediate model. The generation rule may be available as part of the code generation tool 2 or may be stored on the HDD 15 as an external file for the code generation tool 2. A distinction is made between the generation model extraction engine 21 and the code generation engine 22 simply with respect to functions of the code generation tool 2. These engines need not always be provided as separate programs. Actually, in the embodiment, the generation model extraction engine 21 and the code generation engine 22 are implemented as a single program.

The generated source code is converted into an object code by executing a compiler and linker 5 recorded on the HDD 15.

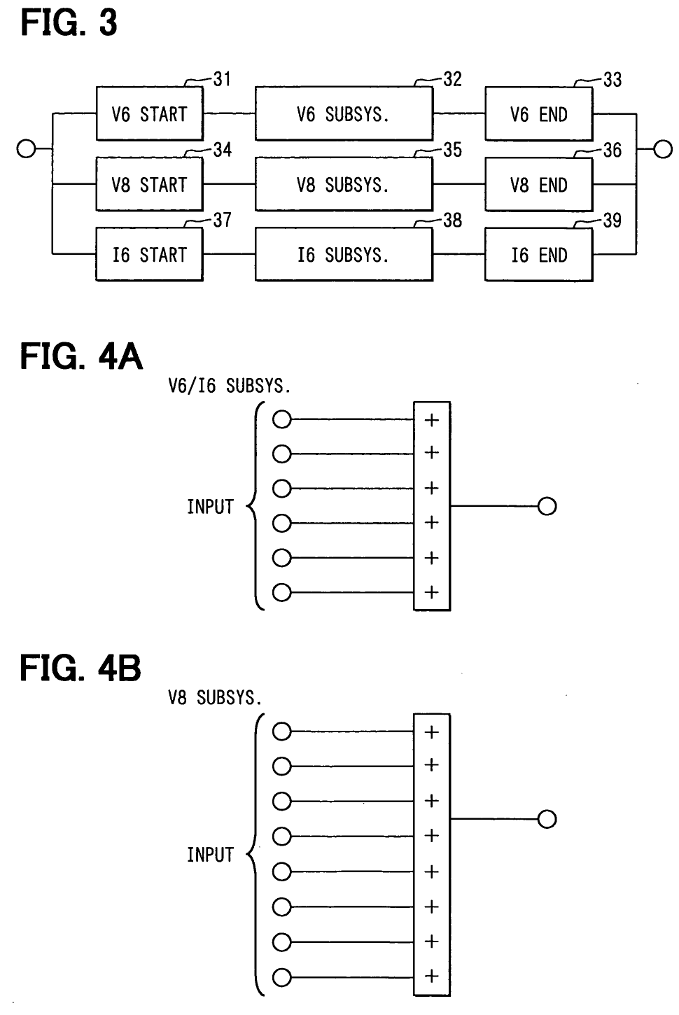

FIG. 3 shows an example of the model 3 input to the code generation tool 2. This model constitutes part of the model for the program installed in the vehicle's engine ECU and includes a V6 start block 31, a V6 subsystem 32, a V6 end block 33, a V8 start block 34, a V8 subsystem 35, a V8 end block 36, an I6 start block 37, an I6 subsystem 38, and an I6 end block 39.

The V6 start block 31, the V6 end block 33, the V8 start block 34, the V8 end block 36, the I6 start block 37, and the I6 end block 39 are part specification blocks. A part specification block belongs to the above-mentioned blocks and is equivalent to a part specifier according to the present invention. The part specification blocks are categorized into start blocks and end blocks. The start blocks include the V6 start block 31, the V8 start block 34, and the I6 start block 37. The end blocks include the V6 end block 33, the V8 end block 36, and the I6 end block 39. One type of start block always corresponds to the same type of end block. In FIG. 3, the V6 start block 31 corresponds to the V6 end block 33, the V8 start block 34 to the V8 end block 36, and the I6 start block 37 to the I6 end block 39.

The V6 subsystem 32, the V8 subsystem 35, and the I6 subsystem 38 are blocks having an aggregate of blocks, i.e., nested blocks. The subsystems include a V6 engine, a V8 engine, and an I6 engine that are blocks to describe functions specific to control of the corresponding engine types.

The above-mentioned blocks have the attribute information using their names such as the V6 start block, the I6 subsystem, and the like. The start block has the attribute information indicating that the block is a start block. The end block has the attribute information indicating that the block is an end block.

The model 3 contains the part specification block as a pair of the start block and the end block corresponding to each other. The part specification block includes blocks, subsystems, and the like enclosed between the start block and the corresponding end block. The part specification block specifies these blocks, subsystems, and the like to be parts corresponding to variations for V6, V8, and I6.

FIG. 4 shows examples of different block representations for the subsystems. The blocks here represent a function to output the entire engine state by adding input states of engine cylinders. FIG. 4A diagrams the block for V6 and I6 subsystems. FIG. 4B diagrams the block for a V8 subsystem. Since a V6 or 16 engine uses six cylinders, the block used has six input terminals. Since a V8 engine uses eight cylinders, the block used has eight input terminals.

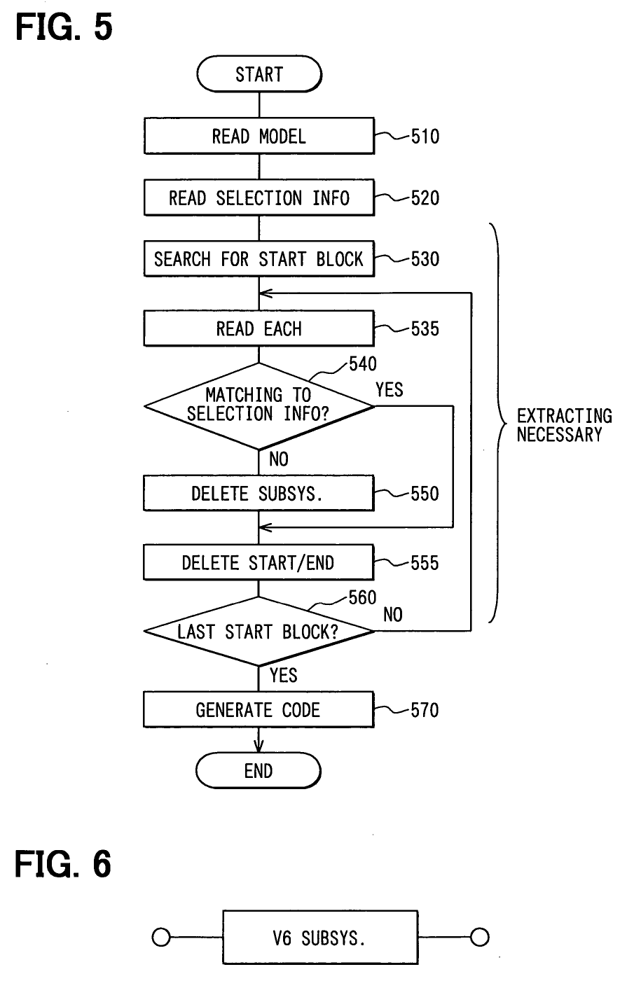

FIG. 5 shows a process to generate a source code from the model. The process starts when a user performs specified operations. With respect to the specified operations, the user operates the input apparatus 12 to specify the model 3 and the selection information 4 to be input to the code generation tool 2. The user then operates the input apparatus 12 to issue a request to start the process in FIG. 5. In the embodiment, the selection information 4 signifies the name of a specific start block. The selection information 4 may be predefined in a specific file on the HDD 15 or may be directly specified by a user when specifying the selection information 4. The following describes the process in FIG. 5.

At Step 510, the process reads the user-specified model 3. Specifically, the process reads a file stored as the model 3 in the HDD 15 and writes the file to the RAM 13.

At Step 520, the process reads the user-specified selection information 4. Specifically, the process reads a file stored as the selection information 4 in the HDD 15 and writes the file to the RAM 13. Alternatively, when information is directly specified from the input apparatus 12, the process writes this information as the selection information 4 to the RAM 13.

At Step 530, the process searches the model 3 for a start block. Specifically, it is determined whether or not the model 3 written to the RAM 13 contains start blocks. When start blocks are found, they are all registered to a start block list that contains attribute information about the start blocks and the other information such as their positions in the model 3. The start block list is written to the RAM 13.

At Step 535, the process reads information about the start block at the beginning of the start block list. The process then deletes the read information about the start block from the start block list. After the first start block information is deleted, information about the next start block becomes the information about the first start block.

At Step 540, it is determined whether or not the name of the start block matches the selection information 4 recorded in the RAM 13. When a match is found, the process advances to Step 555. When no match is found, the process advances to Step 550.

At Step 550, the process deletes a portion between the start block and the corresponding end block, i.e., a portion specified by the part specifier. Specifically, the process searches for the end block corresponding to the start block from this start block toward the end of the model 3. The process then replaces the model 3 in the RAM 13 with the model 3 from which the block between the start block and the found end block is deleted. Here, the start block and end block are not yet deleted. The process then advances to Step 555.

At Step 555, the process deletes the start block and the corresponding end block from the model 3 replaced at Step 550. That is to say, the process replaces the model 3 in RAM 13 with the model 3 from which the start block and the end block are deleted.

At Step 560, it is determined whether or not the start block is the last one. Specifically, if the start block list contains no information about start blocks, the start block is assumed to be the last one. Otherwise, the start block is assumed to be not the last one. In this case, the process returns to Step 535. If the start block is assumed to be the last one, the process advances to Step 570. The process generates a source code from the model 3 recorded in the RAM 13 in accordance with the generation rule 23. The process writes the generated source code as a file in the HDD 15. The process then terminates.

For example, suppose that the model 3 including the blocks in FIG. 3 and the selection information 4 indicative of “V6” are input to operate the code generation tool 2. Here, the code generation tool 2 performs the process from Steps 510 to 560 to generate an intermediate model as shown in FIG. 6. At Step 570, the process generates a source code corresponding to this intermediate model in accordance with the generation rule 23. Accordingly, the generated source code does not contain codes specific to V8 and I6.

The process from Steps 510 to 560 implements the function of the generation model extraction engine 21 in FIG. 2. The process at Step 570 implements the function of the code generation engine 22.

The following describes effects of the personal computer 1 and the code generation tool 2 that are configured and operate as mentioned above.

In the case of creating a model corresponding to a plurality of variations such as V6, V8, and I6, and creating a source code only associated with each of the respective variations, a model 3 is created. This model 3 contains parts corresponding to the variations enclosed in the part specification blocks having names specific to the variations. When creating the source code, the selection information 4 and the model 3 are input to the code generation tool 2. The selection information 4 may be input as a file having the name of the specific variation. Alternatively, a user may manually enter the selection information 4.

The code generation tool 2 then finds subsystems and the like enclosed in the part specification blocks having names other than those specified in the selection information 4. The code generation tool 2 deletes the found subsystems and the like from the model 3, and creates the source code. Therefore, in the development environment where the model compliant with a plurality of variations generates a source code, source codes corresponding to unnecessary variations are removed from the intended source code. Further, this will lead to a decrease in the size of a program generated by the compile and link from the source code and to an economical use of the capacity of memory to record the program.

In the program development environment where the model compliant with a plurality of variations further generates a given model, it is also possible to exclude models corresponding to unnecessary parts of the original model from the given model.

(Second Embodiment)

The following describes the second embodiment of the present invention. This embodiment also includes the hardware configuration and the software configuration as shown in FIGS. 1 and 2. When the second embodiment contains the same parts as the first embodiment, the description thereof will be omitted or simplified.

The second embodiment differs from the first embodiment in the following. While the part specifier of the first embodiment corresponds to the part specification block, the part specifier of the second embodiment is included in the subsystem's attribute information.

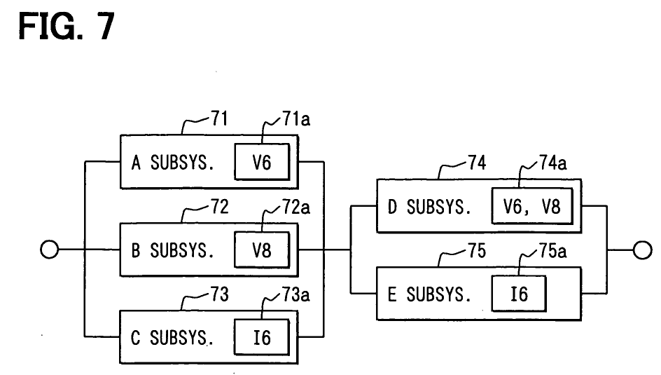

FIG. 7 shows part of the model 3 to be input to the code generation tool 2 according to the embodiment. The model 3 includes A subsystem 71, B subsystem 72, C subsystem 73, D subsystem 74, and E subsystem 75. The subsystems have attribute information 71a, 72a, 73a, 74a, and 75a, respectively. Each attribute information has a selection information item as the part specifier. As the item values, V6 is assigned to the attribute information 71a; V8 to the attribute information 72a; 16 to the attribute information 73a; V6 and V8 to the attribute information 74a; and I6 to the attribute information 75a.

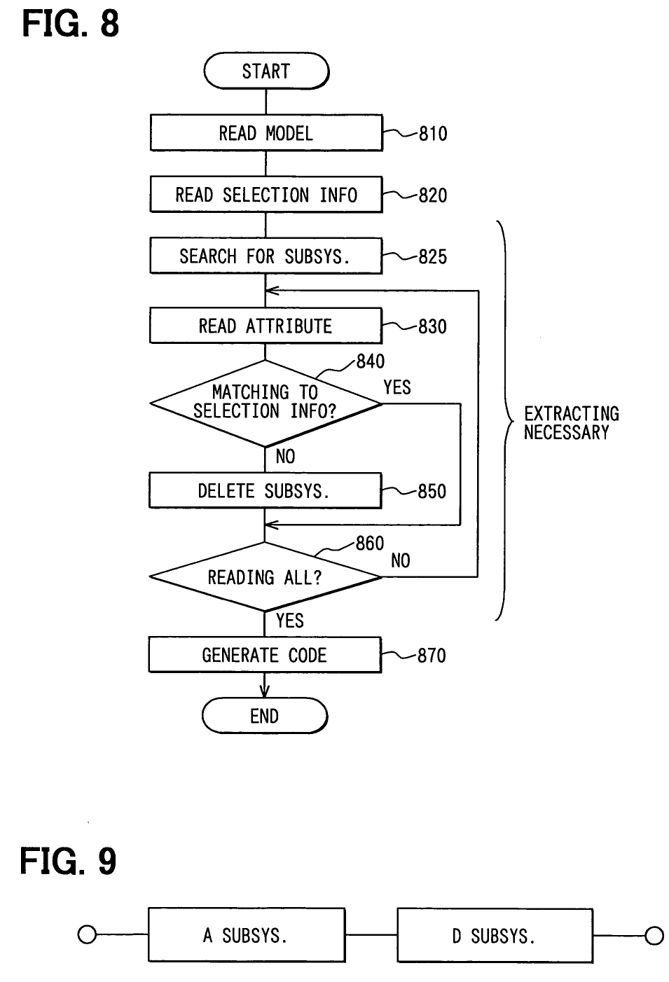

FIG. 8 shows a process to generate a source code from the model. The process starts when a user performs specified operations for the code generation tool 2 according to the embodiment.

The process at Steps 810 and 820 is equivalent to that at Steps 510 and 520 in FIG. 3. In this embodiment, however, the selection information 4 signifies selection information values such as V6, V8, and I6.

At Step 825, the process searches the model 3 for a subsystem. Specifically, it is determined whether or not the model 3 written to the RAM 13 contains blocks as subsystems. When subsystems are found, they are all registered to a subsystem list that contains attribute information about the subsystems and the other information such as their positions in the model 3. The subsystem list is written to the RAM 13.

At Step 830, the process reads information such as the attribute information about the subsystem at the beginning of the subsystem list. The process then deletes the information about the subsystem from the subsystem list. At Step 840, it is determined whether or not the read attribute information contains a variation item to be used that matches the selection information 4. When no match is found, the process advances to Step 850. The process replaces the model 3 in the RAM 13 with the model 3 from which the corresponding subsystem is deleted. The process then advances to Step 860. When a match is found at Step 840, the process advances directly to Step 860.

At Step 860, it is determined whether or not the attribute information about all subsystems has been read. Specifically, if the subsystem list contains no information about subsystems, it is determined that the attribute information about all subsystems has been read. If the subsystem list contains any information about subsystems, it is determined that the attribute information about all subsystems has not been read. In this case, the process returns to Step 830. If the attribute information about all subsystems has been read, the process advances to Step 870. The process generates a source code from the model 3 recorded in the RAM 13 in accordance with the generation rule 23. The process writes the generated source code as a file in the HDD 15. The process then terminates.

For example, the model 3 including the blocks in FIG. 7 and the selection information 4 indicative of “V6” are input to operate the code generation tool 2. The code generation tool 2 performs the process from Steps 810 to 860 to generate an intermediate model as shown in FIG. 9. At Step 870, the process generates a source code corresponding to this intermediate model. Accordingly, the generated source code does not contain codes corresponding to subsystems that do not include “V6.”

The process from Steps 810 to 860 implements the function of the generation model extraction engine 21 in FIG. 2. The process at Step 870 implements the function of the code generation engine 22.

The following describes effects of the personal computer 1 and the code generation tool 2 that are configured and operate as mentioned above.

When creating a model corresponding to a plurality of variations such as V6, V8, and I6, and creating a source code only associated with each of the respective variations, a subsystem corresponding to each variation is provided. The subsystem's attribute information is provided with a variation item to be used. The item value is configured to be the variation corresponding to the subsystem. When creating the source code, the selection information 4 and the model 3 are input to the code generation tool 2. The selection information 4 may be input as a file having the name of the specific variation. Alternatively, a user may manually enter the selection information 4. The item value for the variation to be used may contain any one of V6, V8, and I6, any two of them, or all of them. For example, a subsystem used in common with V6 and I6 needs to contain two values V6 and I6 as items for the variations to be used. A subsystem used in common with all variations needs to contain all the values V6, V8, and I6 as items for the variations to be used. In this manner, the part specifier corresponds to an item value for the variation to be used in the subsystem's attribute information.

The code generation tool 2 then finds a subsystem whose item value for the variation to be used does not contain the name indicated in the selection information 4. The code generation tool 2 deletes the found subsystem from the model 3, and creates the source code. Therefore, in the development environment where the model compliant with a plurality of variations generates a source code, source codes corresponding to unnecessary variations are removed from the intended source code. Further, this will lead to a decrease in the size of a program generated by the compile and link from the source code and to an economical use of the capacity of memory to record the program.

In the program development environment where the model compliant with a plurality of variations generates a given model, it is also possible to exclude models corresponding to unnecessary parts of the original model from the given model.

As another example, there may be a subsystem whose attribute information contains no items for the variation to be used. Alternatively, there may be a subsystem whose item value for the variation to be used contains none of V6, V8, and I6. For such subsystems, it may be preferable to perform the process at Step 840 assuming that the subsystems contain all values V6, V8, and I6 as item values for the variations to be used. This deletes the need for description in the attribute information that a given subsystem is used in common with all variations.

(Third Embodiment)

The following describes the third embodiment of the present invention. When the third embodiment contains the same parts as the second embodiment, the description thereof will be omitted or simplified.

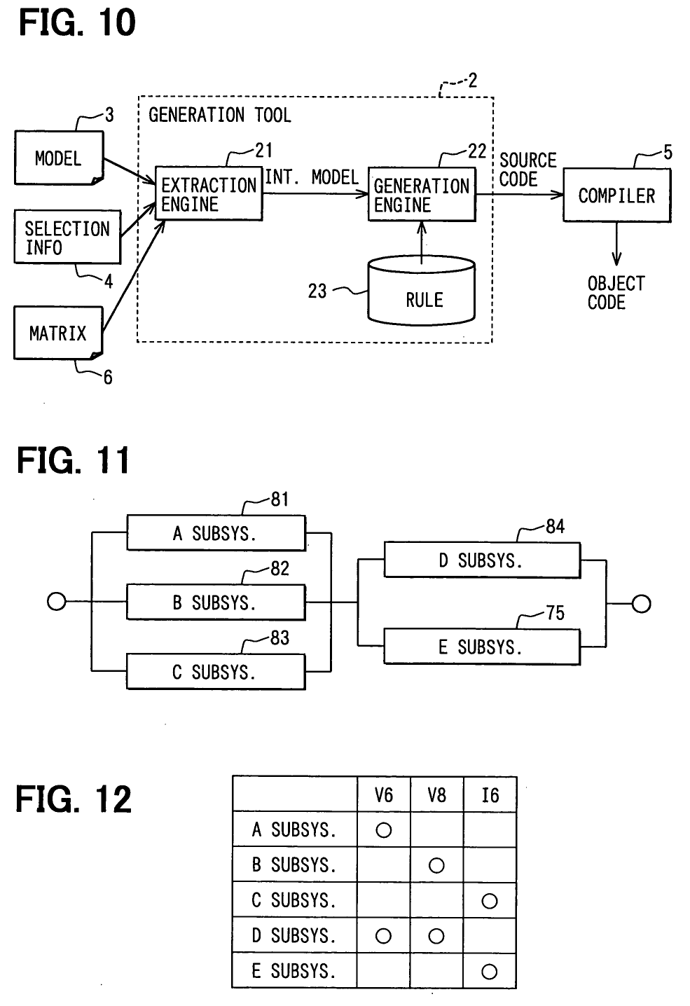

FIG. 10 schematically shows a configuration and operations of the code generation tool 2 according to the third embodiment.

The third embodiment differs from the second embodiment in the following. First, while the part specifier of the second embodiment functions as an item value for the variation to be used in the attribute information, the part specifier of the third embodiment corresponds to a subsystem name. Second, a changeover matrix 6 is used as correlative information indicating correlation between the selection information 4 and the part specifier.

FIG. 11 shows part of the model 3 to be input to the code generation tool 2 according to the embodiment. The model 3 includes A subsystem 81, B subsystem 82, C subsystem 83, D subsystem 84, and E subsystem 85. The subsystems' names are contained in the corresponding subsystems' attribute information.

FIG. 12 shows an example of the changeover matrix 6. The changeover matrix 6 provides information indicative of a matrix including rows and columns. The changeover matrix 6 represents all subsystems included in the model 3 along with variations such as V6, V8, and I6 included in the respective subsystems. Each cell of the changeover matrix 6 is assigned one flag. In FIG. 12, a cell marked with a circle shows that the corresponding flag is set. A blank cell shows that no flag is set, i.e., the corresponding flag is reset. A user can set or reset each flag. In this manner, the changeover matrix 6 represents the correlation between the variations for the rows and the subsystems for the columns. For instance, A subsystem includes a variation of V6, while D subsystem includes variations of V6 and V8.

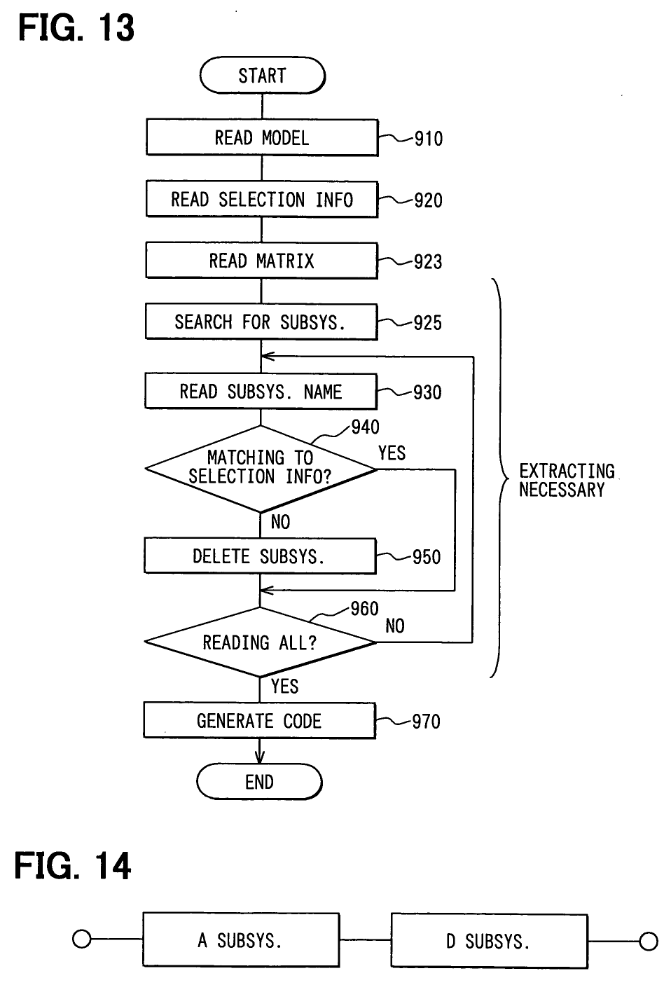

FIG. 13 shows a process to generate a source code from the model. The process starts when a user performs specified operations for the code generation tool 2 according to the embodiment.

The process at Steps 910 and 920 is equivalent to that at Steps 810 and 820 in FIG. 8.

At Step 923, the process reads the changeover matrix 6 specified by the user. Specifically, the process reads a file stored as the changeover matrix 6 in the HDD 15. The process searches the read changeover matrix 6 for a cell setting the flag from the column corresponding to the variation indicated by the selection information 4 that is read at Step 920. The process finds subsystems for the rows that contain the searched cells, creates a list of these subsystems as a selection list, and records it in the RAM 13.

At Step 925, the process searches the model 3 for subsystems in accordance with the same process at Step 825 in FIG. 8.

At Step 930, the process reads information about the name of the subsystem at the beginning of the subsystem list. The process then deletes the information about the subsystem from the subsystem list. At Step 940, it is determined whether or not the read attribute information contains a subsystem name that matches the selection list. When no match is found, the process advances to Step 950. The process replaces the model 3 in the RAM 13 with the model 3 from which the corresponding subsystem is deleted. The process then advances to Step 960. When a match is found at Step 940, the process advances directly to Step 960.

At Step 960, it is determined whether or not all subsystem names have been read. The specific determination process is the same as that at Step 860 in FIG. 8. If it is determined that all subsystem names have not been read, the process returns to Step 930. If it is determined that all subsystem names have been read, the process advances to Step 970. The process generates a source code from the model 3 recorded in the RAM 13 in accordance with the generation rule 23. The process writes the generated source code as a file in the HDD 15. The process then terminates.

For example, the model 3 including the blocks in FIG. 11, the selection information 4 indicative of “V6,” and the changeover matrix 6 having cells set as FIG. 12 are input to operate the code generation tool 2. The code generation tool 2 performs the process from Steps 910 to 960 to generate an intermediate model as shown in FIG. 14. At Step 970, the process generates a source code corresponding to this intermediate model. Accordingly, the generated source code does not contain codes corresponding to subsystems that do not include “V6.”

The process from Steps 910 to 960 implements the function of the generation model extraction engine 21 in FIG. 10. The process at Step 970 implements the function of the code generation engine 22.

The following describes effects of the personal computer 1 and the code generation tool 2 that are configured and operate as mentioned above.

In the case of creating a model corresponding to a plurality of variations such as V6, V8, and I6, and creating a source code only associated with each of the respective variations, a subsystem corresponding to each variation is provided. The changeover matrix 6 which indicates the correlation between subsystem names and variations is created. When creating the source code, the selection information 4, the created changeover matrix 6, and the model 3 are input to the code generation tool 2. The selection information 4 may be input as a file having the name of the specific variation. Alternatively, a user may manually enter the selection information 4.

The code generation tool 2 then finds subsystems that are correlated with variations indicated in the selection information 4 and with flags set in the changeover matrix 6. The code generation tool 2 deletes the other subsystems from the model 3, and creates the source code. Therefore, in the development environment where the model compliant with a plurality of variations generates a source code, source codes corresponding to unnecessary variations are removed from the intended source code. Further, this will lead to a decrease in the size of a program generated by the compile and link from the source code and to an economical use of the capacity of memory to record the program.

In the program development environment where the model compliant with a plurality of variations further generates a given model, it is also possible to exclude models corresponding to unnecessary parts of the original model from the given model.

Unlike the first and second embodiments, subsystems in the model 3 just need to have their proper names. The model 3 need not maintain special information for changing variations. It is possible to centrally manage information for the variation changeover only using the changeover matrix 6 and the selection information 4.

(Fourth Embodiment)

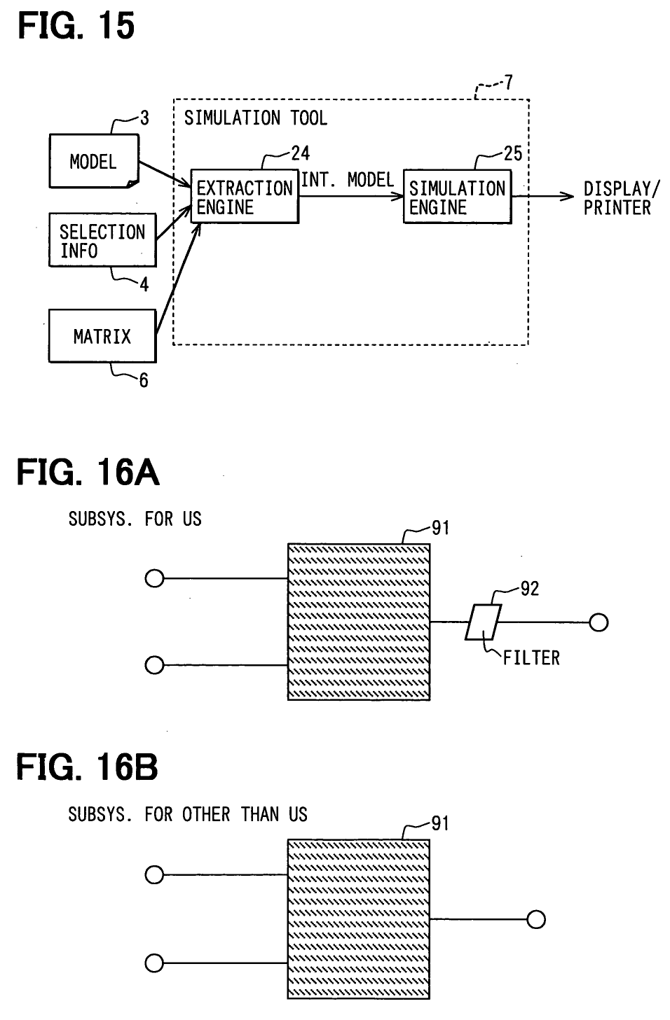

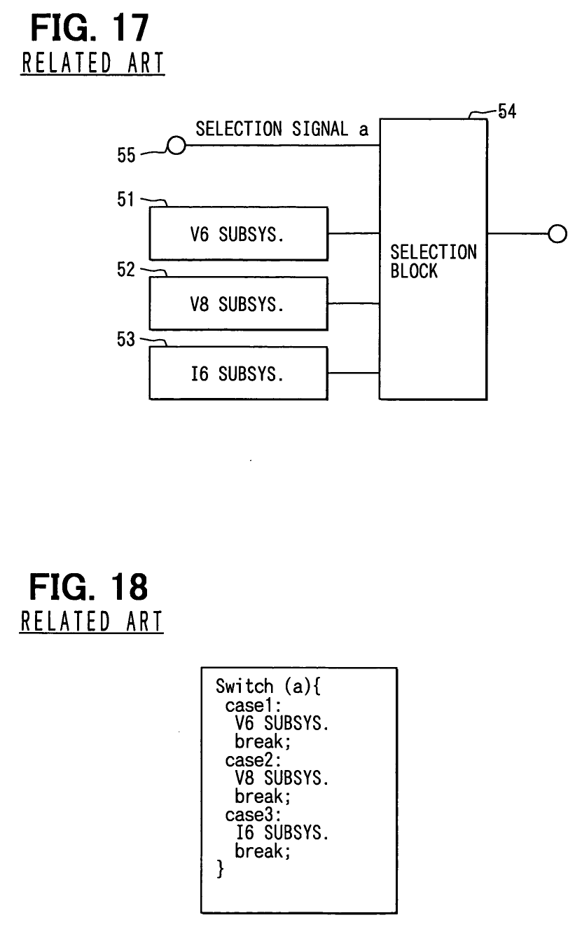

FIG. 15 schematically shows a configuration and operations of a simulation tool 7 according to the fourth embodiment.

The simulation tool 7 is a program that executes another program represented by the model 3 on the personal computer 1 without generating a source code from the input model 3. The simulation tool 7 is used to test or verify operations of a program based on the model 3 before generating a source code by the code generation tool 2 from the model 3 and installing an object code created from the source code into an engine ECU and the like.

The simulation tool 7 can be categorized into a simulation model extraction engine 24 and a simulation engine 25 from the viewpoint of functions.

The simulation model extraction engine 24 has the function equivalent to the generation model extraction engine 21 according to the third embodiment. Specifically, the simulation model extraction engine 24 receives inputs such as the model 3, the selection information 4, and the changeover matrix 6, performs the process at 910 through 960 in FIG. 13, and generates an intermediate model.

The simulation engine 25 uses the personal computer 1 to execute program functions represented by the intermediate model generated by the simulation model extraction engine 24. Specifically, the simulation engine 25 reads the intermediate model and executes a function represented by the intermediate model without converting it into a source code. When executing the intermediate model, the simulation engine 25 outputs information such as input/output data of any user-selected blocks and correlation between them to the display 11 or a printer. For example, the information about correlation between data includes a graph indicating relationship between an accelerator operation and fuel oil consumption.

A distinction is made between the simulation model extraction engine 24 and the simulation engine 25 simply with respect to functions of the simulation tool 7. These engines need not always be provided as separate programs and may be implemented as an integrated program.

The model 3, the selection information 4, and the changeover matrix 6 are the same as those for the third embodiment. In addition, the simulation engine 25 needs to simulate input/output of signals between the model and hardware such as the engine ECU where the model is installed. For this purpose, the model 3 is provided with an additional block to represent input signals from the hardware. The additional block needs to be deleted when the model is input to the code generation tool 2 according to the third embodiment.

In the program development environment where a model compliant with a plurality of variations is executed and its operations are verified, it is also possible to execute the model by excluding functions corresponding to unneeded parts of the original model.

The model 3 may be developed as a program that is actually executed on only specific hardware such as the engine ECU. Before such program is installed on the hardware, program operations can be tested and verified, improving the development convenience.

(Other Embodiments)

In the above-mentioned embodiments, the generated program represents variations such as V6, V8, and I6 for the relevant engine types. The selection information 4 includes information about the relevant engine types. However, the selection information 4 need not always include variations about engine types relevant to a program to be generated. For example, the selection information 4 may include destination countries such as Japan, Europe, and the USA, or may include intended uses of the program such as testing, mass-production. Program functions may depend on destination countries. Since engines are subject to different regulations according to domestic laws of the countries, the program function may contain different parts corresponding to laws and regulations in the respective countries.

FIG. 16 shows configuration examples of blocks that depend on destination countries. FIG. 16A diagrams part of block configuration in a subsystem created for the USA. FIG. 16B diagrams part corresponding to FIG. 16A in a subsystem created for countries other than the USA. A block 91 is shared by both the USA subsystem and the non-USA subsystem. The block 91 applies specified processes to two pieces of input data and outputs one piece of data. A filter block 92 selects data matching a specified range of values out of the input data from the block 91 and outputs the selected data as is. The filter block 92 does not output the other data. Suppose that the USA subsystem specifies an upper bound and a lower bound for output data from the block 91 according to the laws and regulations in order to suppress specific components in the exhaust gas. Here, the filter block 92 is configured to implement restrictions of the laws and regulations.

Furthermore, in the above-mentioned embodiments, the selection information includes information indicating which is to be selected from an original model and to be included in an intermediate model. However, the selection information can be any information relating to selection or deletion of part of the model. For instance, the selection information can also include information indicating which is to be deleted from an original model and not to be included in an intermediate model.

According to the fourth embodiment, the simulation model extraction engine 24 is implemented by the process at Steps 910 through 960. The changeover matrix 6 need not always be used to delete unnecessary subsystems as in the process. For example, this operation can be implemented by the process at Steps 810 through 860 in FIG. 8. Further, it can be implemented by the process at Steps 510 through 560 in FIG. 5. In these cases, the changeover matrix 6 in FIG. 10 is unneeded.

While the code generation tool 2 and the simulation tool 7 according to the first to fourth embodiments generate an intermediate code in the middle of the process, the present invention is not limited thereto. The code generation tool 2 may directly generate a source code from the model 3. The simulation tool 7 may directly execute the model 3. In this case, however, unnecessary parts of the model 3 need to be excluded from the source code. The simulation tool 7 needs to be executed by excluding functions corresponding to unnecessary parts in the model 3.

It will be obvious to those skilled in the art that various changes may be made in the above-described embodiments of the present invention. However, the scope of the present invention should be determined by the following claims.

What is claimed is:

1. A code generation apparatus to generate a source code using a given model, comprising:
model acquisition means for acquiring the given model whose specific part is specified by a part specifier;
selection information acquisition means for acquiring selection information capable of indicating at least one of selection and deletion of the specific part using the part specifier; and
deletion and generation means for generating the source code from a certain model that is generated using the given model acquired by the model acquisition means based on the selection information acquired by the selection information acquisition means.

2. The code generation apparatus of claim 1,
wherein the part specifier includes a part specification block which encloses the specific part of the given model, and
wherein the selection information acquisition means acquires the selection information indicating at least one of selection and deletion of the specific part using the part specification block.

3. The code generation apparatus of claim 1,
wherein the part specifier includes attribute information that is included in the specific part of the given model.

4. The code generation apparatus according to claim 1 further comprising:
correlative information acquisition means for acquiring correlative information indicating correlation between the part specifier specifying the specific part of the given model acquired by the model acquisition means and the selection information acquired by the selection information acquisition means,
wherein the deletion and generation means generates the source code from the certain model that is generated using the given model acquired by the model acquisition means based on the selection information acquired by the selection information acquisition means and the correlative information acquired by the correlative information acquisition means.

5. The code generation apparatus of claim 1,
wherein the selection information includes information about a model type relevant to the source code generated by the deletion and generation means.

6. The code generation apparatus of claim 1,
wherein the selection information includes information about a destination country relevant to the source code generated by the deletion and generation means.

7. The code generation apparatus of claim 1,
wherein the selection information includes information about an intended use relevant to the source code generated by the deletion and generation means.

8. A computer program product on a computer readable medium for use in a code generation apparatus to generate a source code using a given model, the computer program product comprising instructions of:
acquiring the given model whose specific part is specified by a part specifier;
acquiring selection information capable of indicating at least one of selection and deletion of the specific part using the part specifier; and
generating the source code from a certain model that is generated using the acquired given model based on the acquired selection information.

9. A simulation apparatus for executing functions included in a certain model generated using a given model, comprising:
model acquisition means for acquiring the given model whose specific part is specified by a part specifier;
selection information acquisition means for acquiring selection information capable of indicating at least one of selection and deletion of the specific part using the part specifier; and
deletion and generation means for executing the functions included in the certain model that is generated using the given model acquired by the model acquisition means based on the selection information acquired by the selection information acquisition means.

10. A computer program product on a computer readable medium for use in a simulation apparatus for executing functions included in a certain model generated using a given model, the computer program product comprising instructions of:
acquiring the given model whose specific part is specified by a part specifier;
acquiring selection information capable of indicating at least one of selection and deletion of the specific part using the part specifier; and
executing the functions included in the certain model that is generated using the acquired given model based on the acquired selection information.

11. A model generation apparatus to generate a certain model using a given model, comprising:
model acquisition means for acquiring the given model whose specific part is specified by a part specifier;
selection information acquisition means for acquiring selection information capable of indicating at least one of selection and deletion of the specific part using the part specifier; and
deletion and generation means for generating the certain model that is generated using the given model acquired by the model acquisition means based on the selection information acquired by the selection information acquisition means.

12. A computer program product on a computer readable medium for use in a model generation apparatus to generate a certain model using a given model, the computer program product comprising instructions of:
acquiring the given model whose specific part is specified by a part specifier;
acquiring selection information capable of indicating at least one of selection and deletion of the specific part using the part specifier; and
generating the certain model that is generated using the acquired given model based on the acquired selection information.

13. A method in a code generation apparatus to generate a source code using a given model, the method comprising steps of:
acquiring the given model whose specific part is specified by a part specifier;
acquiring selection information capable of indicating at least one of selection and deletion of the specific part using the part specifier; and
generating the source code from a certain model that is generated using the acquired given model based on the acquired selection information.

14. A code generation apparatus to generate a source code using a given model, comprising:
model acquisition means for acquiring the given model, wherein each of a plurality of specific parts included in the given model is specified by each of a plurality of part specifiers;
selection information acquisition means for acquiring selection information indicating at least one of selection and deletion of a given specific part using a given part specifier that specifies the given specific part; and
deletion and generation means for generating the source code from a certain model that is generated using the given model acquired by the model acquisition means based on the selection information acquired by the selection information acquisition means.
